(19) United States
(12) Patent Application Publication
(10) Pub. No.: US 2023/0303854 A1
(43) Pub. Date: Sep. 28, 2023

(54) HOT-MELT ROAD MARKING PAINT COMPOSITION

(71) Applicant: Dusty Whitaker, Childress, TX (US)

(72) Inventor: Dusty Whitaker, Childress, TX (US)

(21) Appl. No.: 17/705,326

(22) Filed: Mar. 27, 2022

(51) Int. Cl. C09D 5/33; C09D 7/61; C09D 193/04

(52) U.S. Cl. CPC C09D 5/004; C09D 7/61; C09D 193/04

(57) ABSTRACT

A hot-melt road marking paint composition is disclosed. The road marking paint composition includes, percentage by weight, 25-45% glass beads, 20-42% calcium carbonate, 18-23% maleic-modified glyceryl ester of rosin, 1-5% polyethylene terephthalate, and 8-15% titanium dioxide or 1-1.5% C.I. Pigment Yellow 83.

### TECHNICAL FIELD

The present invention relates to road marking paint compositions in general, and in particular to a hot-melt road marking paint composition.

### BACKGROUND

Road marking paint are typically utilized for marking lanes, pedestrians' crossings, etc. on roads. Essential components of conventional melt-bonding (or hot-melt) road marking paint include a pigment, a silica, a filler, and a binder.

Melt-bonding road marking paint typically comes in a powder form. Before application, the road marking paint powder is initially melted in a hot melt kettle. The molten road marking paint can then be applied (such as spraying) onto a road surface to form the desired shape for road markings. The road marking paint coated on the road surface can be cooled and solidified in a few minutes.

The road marking paint is required to have properties such as fast drying, wear resistance, diffusive reflectivity, and strong peel strength after solidification.

The present disclosure provides an improved composition for melt-bonding road marking paint.

### SUMMARY

In accordance with one embodiment, a road marking paint composition includes, percentage by weight, 8-15% titanium dioxide, 25-45% glass beads, 20-42% calcium carbonate, 18-23% binder, and 1-5% polyethylene terephthalate.

In accordance with another embodiment, a road marking paint composition includes, percentage by weight, 1-1.5% chrome yellow 83, 30-45% glass beads, 20-42% calcium carbonate, 18-23% binder, and 1-5% polyethylene terephthalate.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a flow diagram of a method for making melt-bonding road marking paint, according to one embodiment.

### DETAILED DESCRIPTION OF A PREFERRED EMBODIMENT

Essential components of conventional melt-bonding road marking paint include a pigment, a silica in the form of glass beads, a filler and a binder along with a plasticizer. The two most common pigment colors are white and yellow. White pigments are mainly titanium dioxide, zinc oxide, and lithophone. Yellow pigment is lead and chromate free, and is also heat-resistant. Silica glass beads, which are generally colorless and transparent, provide light refraction, focusing and directional reflection. Dispensed throughout a road paint coating surface, glass beads can reflect car light back to drivers' eyes to improve visibility of road markings. The filler ensures mechanical strength, wear resistance, and color of paint coating. The binder allows the road marking paint to be fast-drying and strongly adhesive to a road surface.

In accordance with one embodiment of the present invention, polyethylene terephthalate (PET or PETE) is utilized as an additive for manufacturing melt-bonding road marking paint. PET is a polymer resin of the polyester family. The main source of PET can be recycled plastic water bottles. In addition being an additive, PET also replaces certain amount of silica glass beads and filler needed to be employed in conventional melt-bonding paint compositions. For example, the percentage of PET used in the paint composition may replace the same amount of silica glass beads and/or calcium carbonate filler.

### A. White Color Road Marking Paint

Components of white color melt-bonding road marking paint include a white pigment, a silica, a filler, a binder, and an additive.

### White Pigment

The white pigment is a rutile titanium dioxide, which preferably meets the ASTM D 476, Type II or V standard. A maximum of 17% of the total white pigment content may be ASTM D 476 Type I anatase titanium dioxide. When washed free of resins by solvent washing, the white pigment should be able to meet the U.S. Standard Sieve Number 200.

### Silica

Silica glass beads should have an index of refraction between 1.50 and 1.53 at 25° C. Silica glass beads should meet the requirement of AASHTO M247 Type 1.

### Filler

The filler is calcium carbonate of 95% purity.

### Binder

The binder includes a mixture of thermoplastic resins (at least one of which is a solid at room temperature) and one or more plasticizers having a high boiling point. One example of plasticizers is castol oil. At least ⅓ of the binder composition is a maleic-modified glyceryl ester of rosin, and not less than 8% by weight of the entire material composition.

### Additive

PET is utilized as an additive. PET can be formed by pulverizing clear recycled plastic into micron size beads.

Table I shows the composition of a white color melt-bonding type road marking paint in percentages by weight.

TABLE I

| type | materials | % by weight | preferred % |
|---|---|---|---|
| pigment | titanium dioxide | 8-15 | 12 |
| silica | glass beads | 25-45 | 30 |
| filler | calcium carbonate | 20-42 | 35 |
| binder | thermoplastic resins | 18-23 | 22 |
| additive | PET | 1-5 | 1 |
| | | | 100 |

### B. Yellow Color Road Marking Paint

Components of yellow color melt-bonding road marking paint include a yellow pigment, a silica, a filler, a binder, and an additive.

### Yellow Pigment

The yellow pigment should be a lead and chromate free, organic yellow pigment that is heat-resistant. One example of yellow pigment is C.I. Pigment Yellow 83, opaque version.

### Silica

Silica glass beads should have an index of refraction between 1.50 and 1.53 at 25° C. Silica glass beads should meet the requirement of AASHTO M247 Type 1.

### Filler

The filler is calcium carbonate of 95% purity.

### Binder

The binder includes a mixture of thermoplastic resins (at least one of which is a solid at room temperature) and one or more plasticizers having a high boiling point. One example of plasticizers is castol oil. At least ⅓ of the binder composition is a maleic-modified glyceryl ester of rosin, and not less than 8% by weight of the entire material composition.

### Additive

PET is utilized as an additive. PET can be formed by pulverizing clear recycled plastic into micron size beads.

Table II shows the composition of a yellow color melt-bonding type road marking paint in percentages by weight.

TABLE II

| type | materials | % by weight | preferred % |
|---|---|---|---|
| pigment | chrome yellow 83 | 1-1.5 | 1 |
| silica | glass beads | 30-45 | 40 |
| filler | calcium carbonate | 20-42 | 35 |
| binder | thermoplastic resins | 18-23 | 22 |
| additive | PET | 1-5 | 2 |
| | | | 100 |

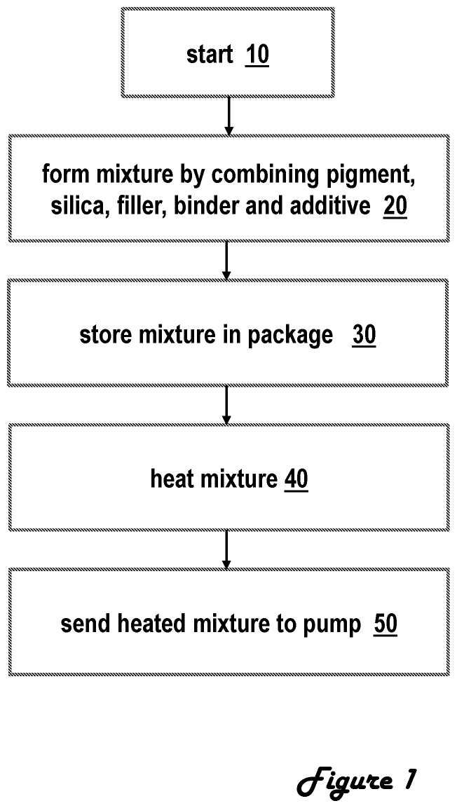

Referring now to the drawings and in particular to FIG. 1, there is depicted a flow diagram of a method for making melt-bonding road marking paint, according to one embodiment. Starting at block 10, a pigment, a silica, a filler, a binder, and an additive are combined in a mixer to form a mixture, as shown in block 20. The pigment, silica, filler, binder, and additive can be in a powder or bead form, and the details of the pigment, silica, filler, binder, and additive are described above. The mixture is then placed in a bag or package for storage, as depicted in block 30. Before application, the mixture is heated to 400-425° F. in a melter, as shown in block 40. Next, the melted mixture is sent through a pump and to provide air atomization, as depicted in block 50. Depending on the application, the road marking paint in its molten form can be applied on roads by using an appropriate painting equipment, such as a sprayer.

As has been described, the present invention provides an improved composition of melt-bonding road marking paints. The usage of PET in the form of recycled plastic can lessen the cost of making melt-bonding road marking paints. In addition, since the source of PET typically comes from recycled plastic bottles, the present invention helps remove excess waste plastics from the environment.

While the invention has been particularly shown and described with reference to a preferred embodiment, it will be understood by those skilled in the art that various changes in form and detail may be made therein without departing from the spirit and scope of the invention.

What is claimed is:

1. A road marking paint composition comprising:
percentage by weight, 8-15% titanium dioxide, 25-45% glass beads, 20-42% calcium carbonate, 18-23% binder, and 1-5% polyethylene terephthalate (PET).

2. The road marking paint composition of claim 1, wherein said binder includes maleic-modified glyceryl ester of rosin.

3. The road marking paint composition of claim 1, wherein said PET is pulverized clear recycled plastic.

4. A road marking paint composition comprising:
percentage by weight, 1-1.5% chrome yellow 83, 30-45% glass beads, 20-42% calcium carbonate, 18-23% binder, and 1-5% PET.

5. The road marking paint composition of claim 4, wherein said binder includes maleic-modified glyceryl ester of rosin.

6. The road marking paint composition of claim 4, wherein said PET is pulverized clear recycled plastic.

7. A method for making melt-bonding road marking paint, said method comprising:
combining a pigment, a silica, a filler, a binder, and an additive to form a mixture, wherein said additive is PET formed by pulverizing clear recycled plastic into beads; and
heating said mixture to 400-425° F. to melt said mixture to form a road marking paint in a molten form.

8. The road marking paint composition of claim 7, wherein said binder include maleic-modified glyceryl ester of rosin.

9. The road marking paint composition of claim 7, wherein said pigment is titanium dioxide.

10. The road marking paint composition of claim 7, wherein said pigment is C.I. Pigment Yellow 83.

11. The road marking paint composition of claim 7, wherein said filler is calcium carbonate.

12. The road marking paint composition of claim 7, wherein said silica is glass beads.
